(19) United States
(12) Patent Application Publication
(10) Pub. No.: US 2018/0265067 A1
(43) Pub. Date: Sep. 20, 2018

(54) Method and Device for Ensuring the Functionality of an Operating Element of a Parking Brake

(71) Applicant: Robert Bosch GmbH, Stuttgart (DE)

(72) Inventors: Bernd Stoehr, Sachsenheim (DE); Toni Frenzel, Heilbronn (DE)

(21) Appl. No.: 15/901,234

(22) Filed: Feb. 21, 2018

(30) Foreign Application Priority Data
Mar. 14, 2017 (DE) 10 2017 204 178.1

(51) Int. Cl. B60T 17/22; G07C 5/08

(52) U.S. Cl. CPC B60T 17/221; G07C 5/0808

(57) ABSTRACT

A method for ensuring the functionality of an operating element operated by an operator for operating an automated parking brake for a motor vehicle includes carrying out a simple quality check of the operating element when a defined first condition is fulfilled. The method further includes carrying out an extended quality check of the operating element when a defined second condition is fulfilled.

This application claims priority under 35 U.S.C. § 119 to patent application no. DE 10 2017 204 178.1, filed on Mar. 14, 2017 in Germany, the disclosure of which is incorporated herein by reference in its entirety.

The present disclosure concerns a method for ensuring the functionality of an operating element operated by an operator for operating an automated parking brake for a motor vehicle that is characterized in that when a defined first condition is fulfilled a simple quality check of the operating element is carried out and an extended quality check of the operating element is carried out when a defined second condition is fulfilled. Furthermore, the present disclosure concerns a device that is embodied to implement the method.

### BACKGROUND

An automatic parking brake (APB)—also referred to as an automated parking brake or an automated holding brake—consists as a rule of an electric motor per wheel of the rear axle of a vehicle, an APB button in the interior of the vehicle and a control unit (Electronic Control Unit, ECU). The electric motor is used in this case for applying and releasing the parking brake. The APB is activated automatically if the vehicle is turned off or stationary for a short time for example. As a rule, the driver can also initiate said process by means of the APB button. In this case, the control unit analyses the button position and then activates the electric motors of the APB in the desired direction.

The control unit monitors said button by suitable measures in order to rapidly detect a fault and to avoid a false interpretation of the button position. A false interpretation of the button could for example result in the parking brake being applied, although the driver has not operated the button. In addition, unintended release of the parking brake could lead to a vehicle rolling away. For this reason, the control unit must reliably detect faults in the button itself, but also in the lines between the button and the control unit. A fault can be signaled to the driver by means of a warning light for example. Faulty actuation of the parking brake is to be prevented in any case. A further aspect of the parking brake is a desired high availability, i.e. the parking brake itself should be capable of detecting fault situations and signaling to the driver, but also be ready for use again once the fault situation has been eliminated. However, it is required in the ECE-R13-H standard that defects may only be cleared if the defect is no longer present. The control unit must therefore also be capable of reliably detecting that a previously present defect that has resulted in signaling to the driver is no longer present.

During the production of the vehicle by the manufacturer of the vehicle, the following situation can occur, for example: The ECU of the APB is already installed in the vehicle and connected to the supply, but the APB button or the lines (cable loom) is not yet installed. This results in a defect entry in the control unit, as no valid state of the APB button can be detected. If the APB button is connected during the further course of production, in the event of a faultless button and cable loom the warning light should extinguish, the defect entry should be cleared and hence a functioning system should be indicated. Said process is a so-called quality check, i.e. following the detection of a defect the ECU is capable of detecting that the defect is no longer present.

In order to achieve a quality check of the APB system, all possible positions of the APB button must be set manually by the assembly worker, so that the control unit can determine that the button and the lines are functioning. Alternatively, special diagnostic software could also clear the defect once the button and lines are installed and connected. Both possibilities (manual operation of the button after the installation or clearing by special diagnostic software) require additional time to be expended during the production of the vehicle or the development of special software.

### SUMMARY

By contrast, the method/device according to the disclosure advantageously enables a distinction to be made between a real defect of the APB button or the lines and a defect that occurs during the production of the vehicle. Said distinction enables the complex testing of all possible positions of the APB button according to ECE-R13-H during production to be omitted. For example, the disclosure thus enables the control unit to be switched on already during production of the vehicle, although there is still no APB button or cabling present and the resulting defect (warning light and/or entry in the defect memory of the vehicle) is to be automatically cleared once a button is connected to the lines in a subsequent production step.

This is enabled according to the disclosure by the features specified in the independent claims. Further embodiments of the disclosure are the subject matter of subordinate claims.

The method according to the disclosure for ensuring the functionality of an operating element operated by an operator for operating an automated parking brake for a motor vehicle is characterized in that when a defined first condition is fulfilled a simple quality check of the operating element is carried out and when a defined second condition is fulfilled an extended quality check of the operating element is carried out.

This is understood to mean that the evaluation of the functionality is carried out adaptively. This means that depending on the present situation or the state of the system of the parking brake and the components thereof, a respectively adapted quality check is carried out. The aforementioned first condition and second condition are in particular to be understood to be alternative situations or states of the system. Furthermore, it is possible for example that a simple quality check is only carried out in a defined situation, wherein in all other possible situations an extended quality check is carried out.

The functionality of the parking brake system can be continuously monitored or even checked periodically or on an ad hoc basis. Both the simple and extended quality checks are carried out in particular in the case in which a defect in the system or a component has been detected, in order to check whether the functionality of the system or of a component is available. In particular, a quality check is carried out to check whether an identified defect continues to exist or has been cleared in the meantime.

A quality check of the operating element can for example be carried out by a control unit. For this purpose, a signal is sent by the operating element and read again at the output of the operating element. Further, the read-in signal is compared with an expected value and based on the comparison it is derived whether the operating element is to be classified as “good” (operational) or “bad” (not sufficiently operational).

The operating element can be an activation signal of a transmitter, an actuating element, a reversing lever, a rotary switch, a slide control, a press button, a pull button or a touch display for example. During the simplified quality check, for example only the rest position of the APB button is checked for function. As a rule, this is carried out by sending a signal through the APB button and reading the signal again at the output of the button. If the signal that is read again agrees with the expected value, then the APB button is in order. During the extended quality check, likewise a signal is sent through the APB button and compared with the expected value. However, said test must be carried out for all available positions of the APB button. I.e., the APB button has three positions and the expected value must be checked and assessed for correctness for all three positions. Only then can the APB button be declared as operational and for example a defect entry can be cleared so that the warning light extinguishes.

Advantageously, an adaptive test results from said approach that is matched to the respective requirement for the current situation. This enables a reduction of the time taken in specific situations if a comprehensive test is unnecessary, without reducing the meaningfulness and reliability of the test. Furthermore, a comprehensive test is carried out for example in situations in which this is necessary to achieve valid evidence about the functionality of a component. The quality check itself advantageously results in the desired high availability of the system and the possibility of detecting a defect that occurs, and also of detecting if a defect is no longer present and accordingly returning the system to operational readiness.

In an advantageous embodiment of the method, a defect memory entry is carried out if no valid signal of the operating element is detected.

A check of the signal of the operating element is carried out as a rule once the control unit is connected or turned on. In this case, a defect in the system is assumed if no valid signal of the operating element is determined on one occasion, for example by the control unit of the parking brake. This can for example be caused by a defect in the operating element itself, and also by the line between the operating element and the control unit. For example, it can arise if no operating element is yet present during the assembly of the vehicle. An assumed lack of functionality of the operating element results in an entry in the defect memory, which is maintained until it has been determined by means of a positive quality check that no defect exists (any longer). Only if a positive quality check is carried out can the entry be cleared from the defect memory. This advantageously enables high reliability to be ensured.

In one possible embodiment of the method, the simple or extended quality check is carried out if there is a defect memory entry in order to determine whether the functionality of the operating element is available.

This is understood to mean that in the event of there being a defect memory entry present, a check is made as to whether the defect is still present or the fault situation has been eliminated. This is carried out by means of the quality check. Depending on the present situation, for example meeting the first or second condition, a simple or extended quality check is carried out accordingly. The respective quality check can be carried out continuously, at time intervals or when caused by a specific trigger. By means of the quality check, advantageously a detected and stored defect can be neutralized again. I.e., a detected defect can be cleared from the memory following the elimination thereof. This results in increased availability of the system and increased operational readiness. Furthermore, the user can advantageously be notified if it is detected that a previously detected defect is now eliminated and no longer exists.

In a preferred embodiment of the method, the simple or extended quality check is carried out if there is a defect memory entry and a valid signal of the operating element is detected.

As already mentioned, the start of a quality check can be initiated by a specific trigger. Such a trigger can for example be a valid detected signal of the operating element. In particular, this can occur if there is a defect memory entry because of a previous signal of the operating element that was not detected or that was detected as invalid. Advantageously, this enables unnecessary quality checks to be avoided and the reliability of detecting an eliminated defect—and hence the availability of the system—to be increased.

In an alternative development of the method, the defect memory entry is cleared in the event of a positive conclusion of the simple or extended quality check.

This is understood to mean that the entry of the detected defect in the defect memory is cleared if it is detected by means of the quality check that the fault situation has been eliminated and for example the component is sufficiently operational. Because of the cleared defect memory entry, the warning lamp that should draw attention to the defect can also be deactivated. The availability and operational readiness of the system can be increased by the internal evaluation by means of the quality check as to whether the defect is eliminated and of the clearance in the positive case. Furthermore, warnings that are no longer necessary are avoided and the number of workshop visits may possibly be reduced.

In an advantageous embodiment of the method, the simple quality check is carried out if a valid operating element signal is detected for the first time.

This is understood to mean that the simple quality check is carried out only in the case where a valid signal of the operating element is actually detected for the first time. The term “for the first time” should be understood to mean during the setting to work of the operating element, in particular during the production of the vehicle or when in the workshop. In particular, this does not mean a normal start of the vehicle in the field, for example after being at a standstill. Furthermore, suitable steps of the method and/or devices are provided to assess and detect that in the event of the detection of a valid signal it is a first-time detection of a valid signal. Advantageously, this enables reduced quality checking to be achieved by the assembly worker during the production of the vehicle for example. In particular, this results in a reduction of the cycle times and the costs.

By storing the successful connection of the operating element (APB button) to the control unit (ECU) for the first time during the production of the vehicle, it can be ensured that all subsequent defects can only be checked well by an extended quality check. Without said memory solution, it would also have to be checked well during the production of the entered defect by an extended quality check. This would increase the cycle times during the production of the vehicle. In addition, automatic clearing of the defect by a special diagnostic software can be omitted by the use of a memory element, and hence development costs for the software can be reduced.

In one possible embodiment of the method, the simple quality check is carried out if in the event of an operating element signal that is detected as valid defined information is not detected in a defined memory element, or if defined information is detected in a defined memory element in the event of an operating element signal that is detected as valid.

This shall be understood to mean that a plurality of alternative versions is conceivable. The first embodiment (“version 1”) provides for this for example that a simple quality check is carried out in the case of defined information not being detected in the defined memory element. I.e., the memory element is not set and/or programmed suitably. An alternative embodiment (“version 2”) by contrast, provides for example that a simple quality check is only carried out if defined information is detected in the defined memory element. I.e., the memory element is suitably set up and/or programmed. Advantageously, this enables a quality check adapted to the respective situation with simple means and with high reliability. This enables the necessity to carry out time-intensive manual re-tests or to have to develop special software for testing to be avoided.

In a preferred development of the method, the extended quality check is carried out if in the event of an operating element signal that is detected as valid defined information is detected in a defined memory element, or if in the event of an operating element signal that is detected as valid the defined information thereof is not detected in a defined memory element.

This shall be understood to mean that a plurality of alternative versions is conceivable. The first embodiment (“version 1”) for example provides that an extended quality check is carried out if defined information is detected in the defined memory element. I.e., the memory element is suitably set up and/or programmed. An alternative embodiment (“version 2”), by contrast, provides that an extended quality check is carried out if defined information is not detected in the defined memory element for example. I.e., the memory element is not set up and/or programmed suitably. This enables it to be advantageously achieved that a complex test is only carried out according to need. Furthermore, this advantageously enables the fulfillment of ECE-R13-H.

In particular, it is advantageously provided that the respective version 1 of the simple quality check and the version 1 of the extended quality check constitute a complementary solution. Alternatively, it is provided that version 2 of the simple quality check and version 2 of the extended quality check constitute a complementary solution.

In an alternative embodiment of the method, in the event of a first-time detection of a valid operating element signal, defined information is stored in a memory element, or information defined previously and stored in a memory element is cleared, wherein the memory element is disposed in particular in the control unit.

This is understood to mean that the method provides a memory element to be influenced in such a way that it is illustrated thereby that a first-time detection of a valid signal has already occurred. For this purpose, in a first alternative “version 1”, corresponding information is written into the memory element, or the memory element is suitably set and/or programmed. The specific information indicates that a first-time detection is carried out. In an alternative embodiment “version 2” by contrast, specific information—previously stored in the memory element—is cleared again. The missing information indicates that a first-time detection has already been carried out.

The memory element can be provided for example in a control unit—in particular in the APB control unit or ESP control unit. In this case, for example an EEPROM, permanently supplied flipflop or RAM memory cells can be used. For clarity, it should be noted that the aforementioned memory element is not the same as the previously described defect memory. But both memory elements may also be integrated within a common electronic component and/or memory. Advantageously, identification of the first-time detection of the operating element and hence a demand-oriented quality check can be enabled by influencing the memory element with simple means and in a reliable manner.

In an advantageous embodiment of the method, during a simple quality check the rest position of the operating element is checked, in particular a signal is sent through the operating element during this and is read again at the output of the operating element and the read signal is compared with an expected value.

Advantageously, in specific application cases a test of the functionality of a component can be carried out with sufficient reliability by a simplified quality check. Advantageously, this is carried out in particular with a small expenditure of time and while avoiding the necessity for special software solutions.

According to the disclosure, furthermore a device is provided that is designed to carry out the described method.

This is understood to mean that the device is embodied to and/or comprises means, when used properly, to carry out a method as previously described. For example, a control unit and/or a memory element and/or an operating element can be considered as a device. I.e. for example, an ESP control unit or APB control unit for ensuring the functionality of an operating element operated by an operator for operating an automated parking brake for a motor vehicle, wherein when a defined first condition is fulfilled a simple quality check of the operating element is carried out and when a defined second condition is fulfilled an extended quality check of the operating element is carried out.

According to the disclosure furthermore, a computer program is provided that is designed to carry out the described method and a machine-readable memory medium, on which the computer program is stored.

According to the disclosure, furthermore a brake system for a motor vehicle with an automated parking brake and a control unit and an operating element operated by the driver for operating the parking brake are provided, wherein the brake system comprises a memory element that is equipped so that when a defined first condition is fulfilled a simple quality check of the operating element is carried out and when a defined second condition is fulfilled an extended quality check of the operating element is carried out.

### BRIEF DESCRIPTION OF THE DRAWINGS

It is to be noted that the features mentioned individually in the description can be combined with each other in any technically meaningful way and represent further embodiments of the disclosure. Further features and functionality of the disclosure arise from the description of exemplary embodiments using the accompanying figures.

In the figures:

FIG. 1 shows a schematic representation of a motor vehicle with an automatic parking brake; and

FIG. 2 shows a representation of the process steps of an embodiment of the disclosure.

### DETAILED DESCRIPTION

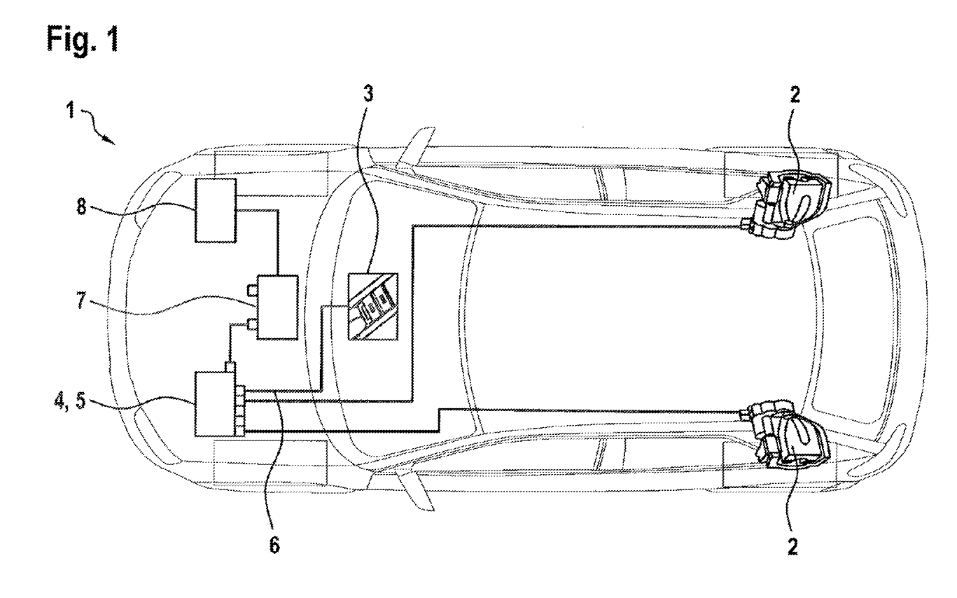

FIG. 1 shows a schematic representation of a motor vehicle 1 with an automatic parking brake 2. In this case, the automated parking brake 2 is embodied on the rear axle of the motor vehicle 1. In this case, the parking brake 2 comprises an electric motor on each wheel that drives a spindle in the hydraulic brake device and thereby displaces a brake piston against the brake lining. The parking brake 2 can be actuated automatically if for example the motor vehicle 1 is in a rest position. Alternatively, the parking brake 2 can be actuated by means of an operating element 3, wherein for example the driver can initiate said process. In this case, the control unit 4 assesses the position of the operating element 3 and forwards a corresponding signal to the electric motor of the parking brake 2. The control unit 4 assesses the signals of a line 6 to the operating element 3 for this. Furthermore, a fuse 7 and a battery 8 are provided. In FIG. 1, moreover, a memory element 5 is represented. This is positioned in the control unit 4. An entry is stored in the memory element 5 for example when a valid operating element signal 3 is detected for the first time. Based on the information placed in the memory element 5, it can therefore be decided whether a simple quality check or an extended quality check must be carried out. For example, a quality check is carried out if a valid operating element signal 3 is detected but there is a defect entry. For example, such a defect entry can be carried out if no valid operating element signal 3 has been detected by the control unit 4. For example, the defect entry can be stored or placed in a further memory of the control unit 4—a so-called defect memory.

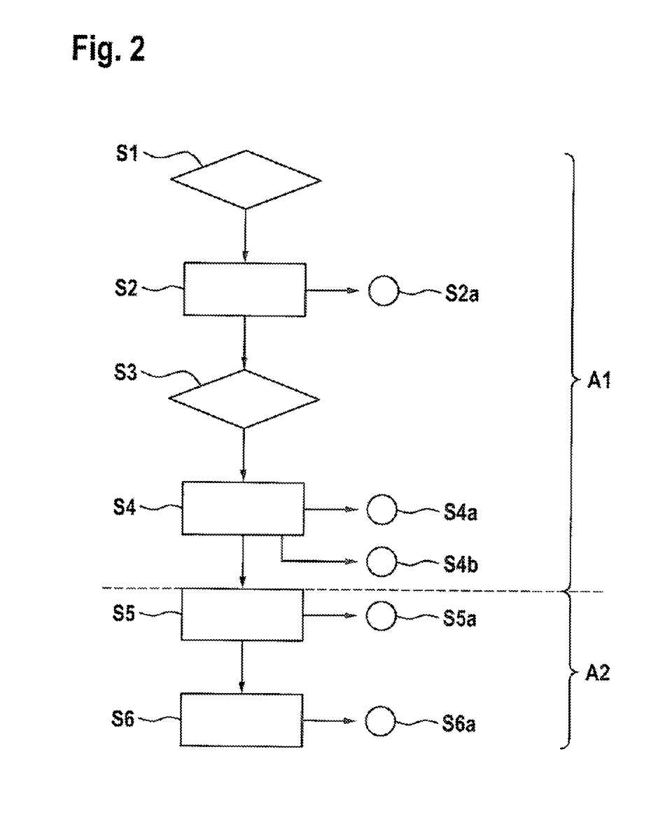

In FIG. 2, a representation of the steps of the method of an embodiment of the disclosure is shown. In this case, in a first step S1 of the method a switch-on is carried out of a control unit that carries out the method, for example the control unit 4 of the automated parking brake 2 (also known as an Electronic Control Unit ECU). For example, the activated control unit 4 checks whether defined conditions are fulfilled. This includes whether a valid operating element signal 3 is detected. If no valid operating element signal 3 is detected in a step S2, a defect memory entry is made in a step S2a. This means that specific information is stored in a memory of the control unit 4. Furthermore, in the step S2a a warning light is activated to communicate to the user that there is a defect. Such a case can for example exist if during the production of the vehicle at the vehicle manufacturer, the control unit of the parking brake is already installed in the vehicle and is connected to the supply, but the APB button or the lines (cable loom) are not yet present or not yet connected. This results in a defect entry in the defect memory of the control unit 4, as no valid state of the APB button is detected. According to the method, however, a further check is made as to whether any valid operating element signal 3 can be detected at a later point in time. If for example the APB button or the lines is/are now connected in the further course of production, a valid operating element signal 3 is detected in a step S4. A check is now carried out for whether a valid operating element signal 3 has been detected for the first time. For this purpose, the memory element 5 is read out, or a check is made as to whether the memory element 5 is set or not. If it is determined that it is a first-time detection, a simple quality check is carried out in the step S4a. Furthermore, defined information “APB button detected” is written into the memory element 5 in a step S4b. Likewise, the defect entry is cleared from the defect memory. As a rule, all the previously described steps take place in a defined first application area A1, namely the production of the vehicle by the manufacturer. The method is however also continued by further steps, which as a rule occur in a defined second application area A2, namely when the motor vehicle 1 is being used normally in the field. The control unit 4 also checks here whether specific conditions are met and/or there are defects. In this case, in a step S5 it can be detected that a line fault or a defect in the operating element 3 is detected, for example if no valid signal from the operating element 3 can be detected. In this case, an entry is made in the defect memory of the control unit 4 again in a step S5a. Likewise, a warning light can be activated to make the user aware of the defect. If in turn a valid operating element signal 3 is again detected in a step S6, a check is made as to whether a simple or extended quality check is to be carried out. For this purpose, the memory element 5 is read or a check is made as to whether the memory element 5 is set or not. As this has already been set during the production of the vehicle, it is now detected that it is not a first-time detection of a valid operating element signal 3 and consequently an extended quality check is carried out in a step S6a.

What is claimed is:

1. A method for ensuring the functionality of an operating element operated by an operator for operating an automated parking brake for a motor vehicle, the method comprising:
carrying out a simple quality check of the operating element when a defined first condition is fulfilled; and
carrying out an extended quality check of the operating element when a defined second condition is fulfilled.

2. The method according to claim 1, further comprising:
making a defect memory entry if a valid operating element signal is not detected.

3. The method according to claim 1, further comprising:
carrying out the simple or extended quality check if there is a defect memory entry and a valid operating element signal is detected.

4. The method according to claim 1, further comprising:
carrying out the simple quality check if a valid operating element signal is detected for a first time.

5. The method according to claim 1, further comprising:
carrying out the simple quality check (i) if defined information is not detected in a defined memory element in the event of an operating element signal that is detected as valid or (ii) if the defined information is detected in a defined memory element in the event of the operating element signal that is detected as valid.

6. The method according to claim 1, further comprising:
carrying out the extended quality check (i) if defined information is detected in a defined memory element in the event of an operating element signal that is detected as valid or (ii) if the operating element signal is detected as valid and the defined information is not detected in the defined memory element.

7. The method according to claim 1, further comprising:
storing defined information in a memory element; or
clearing the defined information previously stored in the memory element if a valid operating element signal is detected for a first time.

8. The method according to claim 7, wherein the memory element is disposed in a control unit.

9. The method according to claim 1, further comprising:
checking a rest position of the operating element during the simple quality check.

10. The method according to claim 9, further comprising:
sending a signal through the operating element;
reading the signal again at an output of the operating element; and
comparing the read-in signal with an expected value during the checking of the rest position of the operating element during the simple quality check.

11. The method according to claim 1, wherein a device is configured to carry out the method.

12. The method according to claim 1, wherein a computer program is configured to carry out the method.

13. The method according to claim 12, further comprising:
a machine-readable memory medium on which the computer program is stored.

14. A brake system for a motor vehicle with an automated parking brake and a control unit and an operating element operated by the driver for operating the parking brake, the brake system comprising:
a memory element configured such that when a defined first condition is fulfilled a simple quality check of the operating element is carried out and when a defined second condition is fulfilled an extended quality check of the operating element is carried out.
